(19) United States
(12) Patent Application Publication
(10) Pub. No.: US 2025/0153386 A1
(43) Pub. Date: May 15, 2025

(54) CHAINSAW GUIDE BAR AND METHOD OF MANUFACTURING THE SAME

(71) Applicant: HUSQVARNA AB, Huskvarna (SE)

(72) Inventor: Christian LILIEGARD, Huskvarna (SE)

(21) Appl. No.: 18/941,386

(22) Filed: Nov. 8, 2024

(30) Foreign Application Priority Data
Nov. 9, 2023 (SE) 2351283-3

(51) Int. Cl. B27B 17/02; B23K 26/21

(52) U.S. Cl. CPC B27B 17/025; B23K 26/21

(57) ABSTRACT

This disclosure relates to a guide bar for a handheld chainsaw. The guide bar comprises first side plate, a second side plate and a core plate, wherein the core plate is arranged between the first side plate and the second side plate providing the guide bar extending in a guide bar plane along a longitudinal direction. Each side plate is provided with a respective opening arrangement, each arrangement comprising at least one elongated opening extending in the longitudinal direction of the guide bar and fully through each side plate. The core plate is provided with an aperture arrangement, comprising a plurality of apertures, each extending fully trough the core plate. Each of the at least one elongated opening is provided with a respective plastic insert. The disclosure also relates to a method of manufacturing of a guide bar.

### FIELD OF THE INVENTION

The present invention relates to a guide bar for guiding the saw chain of a handheld chainsaw, and a method of manufacturing the same.

### BACKGROUND

A handheld chainsaw comprises a moving saw chain, which is guided in a guide track along the periphery of a generally flat, elongated guide bar. Chain saws are often used in rough and remote terrains. The weight of the chainsaw and the guide bar is a factor that affects the comfort and performance of the chainsaw operator. Efforts have been made to produce a lightweight guide bar, but problems have been encountered with good durability and toughness for extended use. U.S. Pat. No. 9,272,438 discloses a guide bar for a chain saw with an elongated main body of steel. The main body has flat sides and upper and lower peripheries defining a guide track for a saw chain. An elongated window is formed in the main body between the peripheries and is filled with a fibre composite material made up of fibre layers and resin.

There is however a strive to increase the durability of a lightweight guide bar and to improve the work environment of the chainsaw operator.

### SUMMARY

It is an object of the present invention to solve, or at least mitigate, parts or all the above-mentioned problems. To this end, there is provided a guide bar for a handheld chainsaw comprising a first side plate, a second side plate and a core plate, wherein the core plate is arranged between the first side plate and the second side plate, the guide bar extending along a guide bar plane P in a longitudinal direction L. Each side plate is provided with a respective opening arrangement, each comprising at least one elongate opening extending in the longitudinal direction of the guide bar and fully through the respective side plate, and the core plate is provided with an aperture arrangement, comprising a plurality of apertures, each extending fully through the core plate. Each of the respective at least one elongate opening of the side plate is provided with a respective plastic insert. By providing the side plates and the core plate with apertures, a guide bar with low weight corresponding to guide bar made of solid side plates and core plate is obtained. By introducing a plastic insert into the respective opening(s) of the side plates, a guide bar with flat outer faces may be obtained, wherein the plastic inserts may be flush with the outer faces of the respective side plates. The guide bar will have high stiffness and strength due the low weight of the plastic inserts compared to the side plates, and due to the plurality of apertures of aperture arrangement, which results in a maintained stiffness of the core plate. This kind of guide bar may be used by for example arborists, where low weight of the guide bar is of high priority when climbing trees.

Preferably, the plastic inserts are separated from each other by the core plate. Thereby, the core plate may act as a spacer between the plastic inserts, so as to ascertain a predetermined gap between them. The apertures of said aperture arrangement may be covered by the side plates and/or the plastic inserts. Thereby, the apertures may at least partly define enclosed voids within the guide bar. This results in a particularly low weight. The apertures need not be completely empty; for example, some of them may be partly or completely filled with e.g. adhesive.

Preferably, said aperture arrangement of the core plate is at least partly positioned between the plastic inserts, such that the apertures are at least partly covered by the plastic inserts.

According to embodiments, the aperture arrangement may comprise between 5 and 25 apertures. Preferably, each aperture of the aperture arrangement has an area of at least 10 cm².

Preferably, the core plate and/or the side plates are made of metal, for example steel.

Preferably, the plastic insert may be a fiber reinforced plastic laminate. This material comprises fiber incorporated in plastic, resulting in material properties such as high stiffness and strength per weight unit, and is well suited for a guide bar where low weight with maintained stiffness is sought.

In one embodiment, the plastic insert may be a carbon fiber reinforced plastic laminate. This material may comprise individual carbon fibers that have been introduced in the same or different directions in the plastic material, or bundles of carbon fiber that have been woven to a matrix that has been embedded in the plastic material. Thermosetting plastics and thermoplastics can be used as plastic material. The plastic material is tasked to hold the fibers in place, transfer load to the fibers and protect the fibers from external impact. Epoxy resin is preferably used as the plastic material for the carbon fiber reinforced plastic laminates.

Preferably, the respective opening arrangements of the side plates may each comprise exactly one single elongated opening provided with a respective plastic insert. Such an opening arrangement results in a guide bar which is particularly easy to manufacture.

In one embodiment, each respective opening arrangement can cover at least 50% of an area enclosed by a perimeter of the side plates.

Preferably, each respective opening arrangement may cover 50-75% of an area enclosed by the perimeter of the respective side plate.

Each side plate can be defined by a piece of hardened steel sheet having a thickness of for example between 1,0 and 1.8 mm. The elongated opening arrangement in each side plate may be one single, large opening that covers the main part of an area enclosed by a perimeter the respective side plate. This solution provides few attachment points between each plastic insert and the respective side plate, which in turn provides few points where a break can occur between respective laminate and the side plate. A lighter guide bar may also be provided if a great part of each side plate can be exchanged by a plastic material.

According to embodiments, said aperture arrangement of the core plate may cover at least 50% of an area enclosed by a perimeter of the core plate; more preferably, the aperture arrangement may cover at least 75% of the area enclosed by the perimeter of the core plate.

In one embodiment, the core plate may be provided with a first and a second longitudinal edge, extending in the longitudinal direction of the guide bar, the longitudinal edges can define the bottom of a guide track for a saw chain and form a part of a frame enclosing the aperture arrangement. The core plate can be provided from a mild steel having a thickness of between 1,28-1.65 mm. The side plates may have the same size, while the core plate has a slightly smaller width and length than the side plates, creating a track around the periphery of the guide bar and the longitudinal edges of the core plate determines the depth of the track. The longitudinal edges border against the aperture arrangement and forms a part of a core plate frame that encloses the aperture arrangement.

Preferably, the core plate can be provided with ribs extending along the guide bar plane. Some ribs may, for example, extend from the core plate frame towards the centre of the core plate. The ribs may extend from the frame in different directions, but some ribs, which may be relatively shorter, may be arranged transversal, for example perpendicular, to the longitudinal direction of the guide bar, whereas other ribs, which may be relatively longer, may extend along the longitudinal direction of the guide bar. The ribs can act as separation walls between the apertures of the aperture arrangement. The ribs may also provide support for the inserts arranged in the side plates and can act as spacers between the inserts. The ribs can also provide a support for the guide bar at parts which are exposed to great stress during operation of the chain saw. The length of transversal ribs may be e.g. between 5 and 35 mm, more particularly between 4 and 15 mm, whereas longitudinal ribs may have a length of, for example, more than 50 mm.

In one embodiment, the guide bar may have a proximal longitudinal end configured to be attached to a chainsaw body, a distal longitudinal end provided with a nose wheel, and a longitudinal centre between said proximal and distal longitudinal ends, wherein the core plate extends from the longitudinal centre towards each of said proximal and distal longitudinal ends. Thus, the core plate extends between the longitudinal ends of the guide bar and forms support for the plastic inserts along the entire length of each insert. Most of the area of the core plate consists of apertures. Preferably, 70-90% of the area that is enclosed by a perimeter of the core plate is apertures, which further affects the weight of the guide bar.

Preferably, each side plate can be provided with a respective first longitudinal edge and a respective second longitudinal edge, opposite to the first longitudinal edge, extending in the longitudinal direction of the guide bar and defining a side plate frame enclosing the at least one opening of the opening arrangement. The longitudinal edges of the side plates also provide the longitudinal edges of the guide bar. The outer faces of the side plates form a first and a second side of the guide bar. The sides of the guide bar are flat.

In one embodiment, the core plate and the side plates may be joined along their longitudinal edges. Different methods can be used for joining the plates, for example welding, normally spot welding or pressure welding, brazing, adhesives, mechanical fasteners, such as rivets or bolts, or other well-known means of attachment.

Preferably, the core plate and the side plates can be welded together along the longitudinal direction of the guide bar. The plates may be joined by welding a first weld seam on the first side of the guide bar and welding a second weld seam on the second side of the guide bar. By welding the stacked plates together via said first and said second weld seams, the stress generated by the weld seams will counteract each other and thereby reducing the stress-induced warp of the guide bar. Welding of the weld seams may comprise applying an energy beam to create the seams. Energy beam welding, such as electron beam welding or laser beam welding may be used. The seams are preferably made by laser beam welding, which method facilitates obtaining a deep and narrow weld in combination with a narrow heat-affected zone, which reduces warp. Reduced warp reduces the wear on the saw chain and the guide bar. It also results in a more accurate shape and uniform width of the guide track along the guide bar, which reduces any sideways meandering tendencies of the chain motion, resulting in an improved user experience and a more precise cut.

Preferably, the guide bar may be provided with an adhesive joining the plastic inserts in respective side plate with each other.

In one embodiment, the adhesive can further be provided for joining the plastic inserts with the core plate and/or the side plates.

Different types of adhesives may be used but preferably can methacrylate be used. Methacrylate is a 2-component adhesive which cures at room temperature, adheres well to both plastics and metal, and is suitable for relatively thick joints. The adhesive may be introduced to guide bar as strings injected to the guide bar between the side plates. Preferably, a string can be introduced at the centre of the guide bar and extends in the longitudinal direction thereof. This adhesive string may bond the carbon fiber reinforced plastic laminates to each other and to the core plate.

Preferably, the guide bar may be provided with an interlock space between the side plates and the core plate at their longitudinal edges, and the adhesive spans a gap between the plastic inserts, and is interlocked in the interlock space. In the area between the longitudinal edges of the side plates and the core plate an interlock space may formed due to the position of the plates in relation to each other. A string of the adhesive may be injected to the guide bar at each of the longitudinal edges thereof. These adhesive strings may bond both the plastic laminates to each other and to the side plates and the core plate. Since the adhesive adhere better to plastic than metal, the adhesive will lock mechanically between the side plates and reduce the risk of that the plastic laminates detaches from the guide bar when subjected to bending or other stresses.

When the plastic laminates have been attached to the guide bar, the outer faces of the guide bar are flat. The edge around the perimeter of each plastic laminates is in line with, i.e. flush with, the edge around the inner perimeter of each elongated opening.

According to a second aspect, parts or all the above-mentioned problems are solved, or at least mitigated, by a method of manufacturing a guide bar for a handheld chainsaw, the method may comprise the steps:
providing a first and a second side plate, each with an opening arrangement, with at least one elongated opening extending in the longitudinal direction of the guide bar and fully through the respective side plate,
providing a core plate with an aperture arrangement, comprising a plurality of apertures enclosed by a frame, extending fully through the core plate;
arranging the core plate between the first and the second side plates to form a stacked sandwich structure;
welding the core plate to the side plates to form an elongated guide bar blank, extending in the longitudinal direction of the guide bar;
after welding, machining the welded seams in an optional machining step, to be level with the outer faces of the side plates;
optionally, hardening at least a portion of the elongated guide bar blank;
optionally, tempering at least a portion of the elongated guide bar blank;
optionally, and preferably after any optional tempering step, induction hardening the longitudinal edges of the welded guide bar blank, for example to a depth of about 1 mm, and
inserting a pre-baked and cut plastic insert in the at least one elongated opening of the opening arrangement of each side plate.

In one embodiment, the method may further comprise applying, for example injecting, an adhesive for joining the plastic laminates with each other and/or with the guide bar blank.

According to this method, the guide bar blank is completed and any steps involving heat treatment may be done before the plastic laminates are introduced to the guide bar blank for formation of the final guide bar. The plastic laminates are pre-baked and cut into the size of the at least one elongated opening of the opening arrangement of each side plate before the laminates are inserted and adhered to the guide bar blank. Methacrylate may be used as adhesive for binding the plastic laminates to the guide bar blank. The adhesive can preferably be injected into the guide bar blank as strings. One string may the injected to the centre of the guide bar blank, between the side plates, to extend in the longitudinal direction thereof for bonding of the plastic laminates to each other and to the core plate. A string may be injected along each of the longitudinal edges of the guide bar blank for bonding of the plastic laminates to each other and to the side plates.

In one embodiment, the method may further comprise the steps of, before inserting the plastic laminates in each side plate: attaching a nose sprocket arrangement to a front end of the guide bar blank seen in the longitudinal direction thereof, between the side plates; painting the guide bar blank. This can enable the use of existing production equipment and logistical flow that may ensure fundamental guide bar properties. Attaching the plastic laminates after painting may also avoid masking of the plastic laminates and can prevent paint on the plastic laminates for cosmetic reasons. Pre- and/or post treatments during painting could potentially be aggressive to the plastic laminates.

According to a third aspect, parts or all the above-mentioned problems are solved, or at least mitigated, by a guide bar that can be manufactured using the method according to the second aspect of the invention. In this way it is possible to obtain a lightweight guide bar, which as the same time has high stiffness and reduced risk that the plastic laminates let go from the guide bar due to insufficient bonding between the plastic laminates and the guide bar. The design of the guide bar can employ techniques to ensure basic guide bar properties.

It is noted that embodiments of the invention may be embodied by all possible combinations of features recited in the claims. Further, it will be appreciated that the various embodiments described for the device are all combinable with the method as defined in accordance with the second aspect of the present invention, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 illustrates a plan view of a handheld chainsaw comprising a saw chain guided by a guide bar;

FIG. 2 is a side view illustrating the interplay between a saw chain drive sprocket, a saw chain, and a guide bar of the chainsaw of FIG. 1;

FIG. 3 illustrates a perspective view of the guide bar of FIG. 1;

FIG. 4 illustrates a plan view of a side plate of the guide bar of FIG. 3;

FIG. 5 illustrates a plan view of a core plate of the guide bar of FIG. 3;

FIG. 6 illustrates the guide bar of FIG. 3;

FIG. 7 corresponds to the illustration of FIG. 6, but with one side plate broken away to illustrate the application of adhesive in the guide bar;

FIG. 8 is a section view of the guide bar of FIG. 3; and

FIG. 9 is a flow chart illustrating a method of manufacturing the guide bar of FIG. 6;

All the figures are schematic, not necessarily to scale, and generally only show parts which are necessary to elucidate the embodiments, wherein other parts may be omitted.

### DETAILED DESCRIPTION OF THE EXEMPLARY EMBODIMENTS

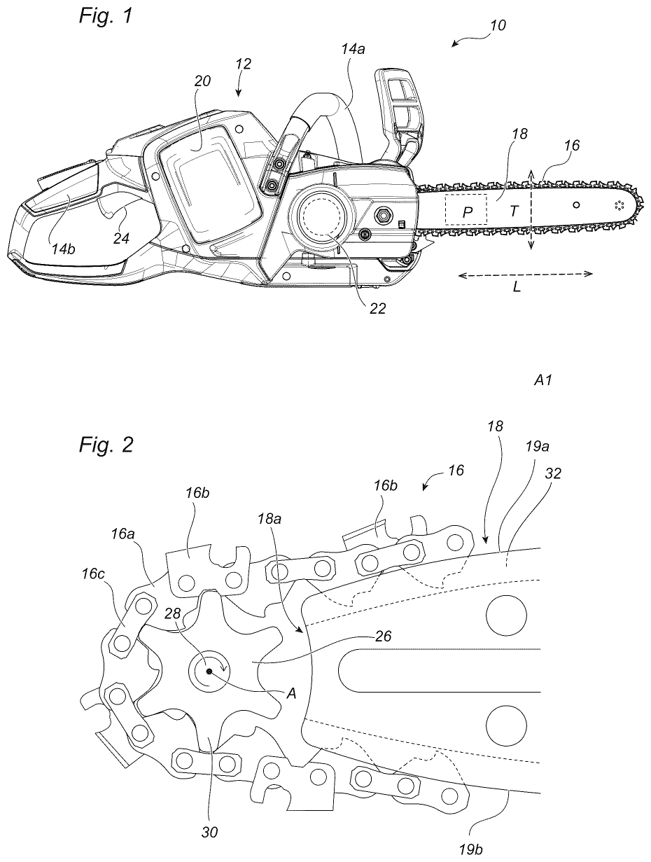

FIG. 1 illustrates a handheld chainsaw 10. The chainsaw 10 comprises a chainsaw body 12 provided with a pair of handles 14a, 14b, by means of which an operator may hold and operate the chainsaw 10. The pair of handles 14a, 14b comprises a front handle 14a, for holding with one hand, for example the left hand, and a rear handle 14b for holding with the other hand, e.g. the right hand. A cutting assembly comprising a saw chain 16, and an elongated guide bar 18 for guiding the saw chain 16 in an elongated loop, extends from a front end of the chainsaw body 12 in a longitudinal direction L of the guide bar 18. The guide bar 18 extends in a guide plane P defined by the longitudinal direction L and a transversal direction T of the guide bar 18, which transversal direction T is perpendicular to the longitudinal direction L. The chainsaw 10 further comprises a removable battery 20, an electric motor 22, and a finger-operated trigger 24 permitting the operator to selectively operate the saw chain 16 using the electric motor 22. Even if FIG. 1 illustrates a battery-powered chainsaw 10, the exemplary guide bar can alternatively be used on handheld chainsaws 10 powered by an internal combustion engine, which are well known in the art.

FIG. 2 schematically illustrates a saw chain drive sprocket 26, a short section of the saw chain 16, and a proximal end 18a of the guide bar 18 as seen from the side. The saw chain sprocket 26 is rotated about a rotation axis A by the motor 22 (FIG. 1) via a motor shaft 28 and drivingly engages with the saw chain 16 to move the saw chain 16 along the guide bar 18. The saw chain 16 comprises drive links 16a meshing with drive teeth 30 of the saw chain drive sprocket 26. The drive links 16a ride in a guide track 32 of the guide bar 18. Cutter links 16b are provided with cutting teeth adapted to shave off wood chips from the material being cut and tic straps 16c to connect the parts in the saw chain 16. The cutter links 16b and the tie straps 16c ride on longitudinal edges 19a, 19b of the guide bar 18.

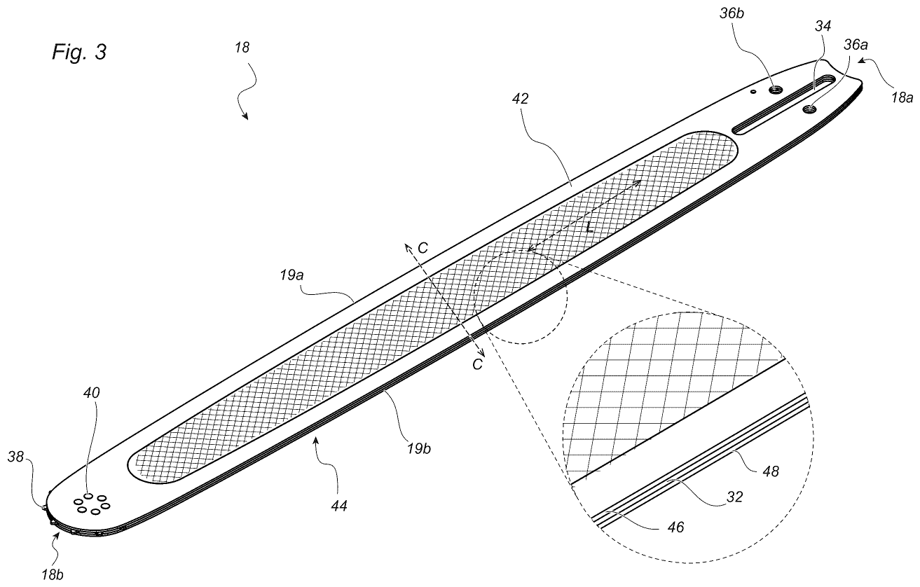

FIG. 3 is a perspective view and illustrates the guide bar 18. A proximal end 18a of the guide bar 18 comprises a longitudinal slot 34 and a pair of adjustment holes 36a, 36b on either side of the slot 34. The slot 34 and the adjustment holes 36a, 36b allow attaching the guide bar 18 to the chainsaw body 12 (FIG. 1) in a matter permitting longitudinal adjustment of the position of the guide bar 18, to allow tensioning of the saw chain 16 (FIG. 1). A distal end 18b of the guide bar 18 may house a nose wheel 38, of which only the outer tips of its gear teeth are visible in FIG. 3, that is rotatable to interface with the saw chain 16 as the saw chain 16 turns around the distal end 18b of the guide bar 18. The nose wheel 38 may be attached to the distal end 18a of the guide bar 18 via pins or rivets 40 extending perpendicular to the guide bar plane P. The guide bar 18 has a first side 42 and a second side 44 opposite to the first side 42, the sides 42, 44 extending parallel to the guide bar plane P (FIG. 1).

A magnified portion of FIG. 3 illustrates details of the structure of the guide bar 18. The guide bar 18 comprises a first side plate 46, a second site plate 48 and a core plate (not visible in this figure), sandwiched between the side plates 46, 48 and separates the side plates 46, 48 from each other. A guide track 32 is defined by a gap between the first 46 and second 48 side plates, and guides the saw chain 16 in a manner as described with reference to FIG. 2. The outer faces of the side plates 46, 48 define the first 42 and second 44 sides of the guide bar 18.

The guide bar 18 has a first longitudinal edge 19a, and a second longitudinal edge 19b, opposite to the first longitudinal edge 19a, each edge 19a, 19b extends along the longitudinal direction L from the proximal end 18a to the distal end 18b of the guide bar 18. The longitudinal edges 19a, 19b of the guide bar 18 are defined by longitudinal edges of the side plates 46, 48.

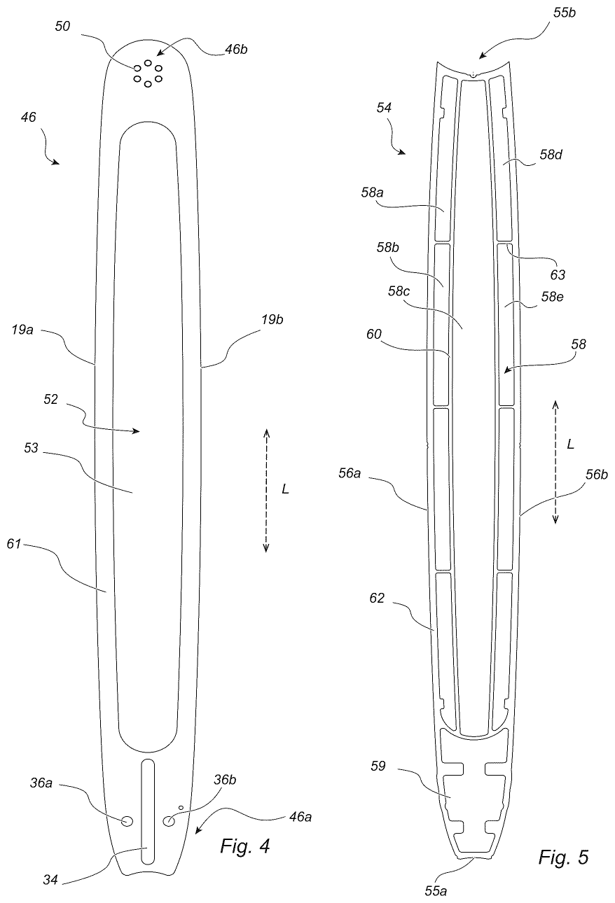

FIG. 4 illustrates a side plate 46 prior to formation of the guide bar 18. In the example embodiment, the opposite side plate 48 is not shown but it identical to side plate 46 shown. Alternatively, the side plates 46, 48 can have different format depending on the desired weight and area of use of the guide bar 18.

The side plates 46, 48 are normally made of the same material, which can be steel or other enough rigid and durable materials. In this example embodiment, the side plates 46, 48 are made of high-carbon steel having a carbon content of about 0.65% by weight and are cut out from steel sheets. The side plates 46, 48 are cut out from a piece of steel sheet having a thickness for example between 1,0 and 1.8 mm, and are hardened.

A proximal end 46a of the side plate 46 comprises a longitudinal slot 34 and a pair of adjustment holes 36a, 36b on either side of the slot 34. The slot 34 and the adjustment holes 36a, 36b are identical to the slot and adjustment holes of the guide bar 18, as indicated in FIG. 3. A distal end 46b of the side plate 46 comprises an attachment arrangement in the form of through holes 50 for attachment of the nose wheel 38 (FIG. 3) to the guide bar 18. The longitudinal edges 19a, 19b of the guide bar in FIG. 3 correspond to the longitudinal edges 19a, 19b of the side plates 46, 48. To reduce the weight of the guide bar 18, each side plate 46, 48 has been provided with an opening arrangement 52. In the exemplary embodiment of FIG. 4, the opening arrangement 52 comprises exactly one elongated through hole extending in the longitudinal direction L of the guide bar 18, even though the opening arrangement may alternatively comprise more than one such elongated through hole; again, it will be appreciated that the second side plate 48 may be identical. In the shown embodiment, the opening arrangement 52 comprises one elongated opening 53 that covers the main part of the area between the proximal end 46a and the distal end 46b. At least 50%, preferably 50-75% of area consist of the elongated opening 53. The longitudinal edges 19a, 19b of each side plate 46, 48 are adjacent to the elongated opening 53 and form part of a frame 61 enclosing the elongated opening 53.

The core plate 54 is illustrated in FIG. 5. The core plate 54 can be made of the same material as the side plates 46, 48, or in a different material. In the example embodiment, the core plate 54 is made of a mild steel having a carbon content of about 0.1% by weight and is cut out from a sheet metal. The core plate 54 is cut out from a piece of steel sheet having a thickness of 1.57 mm; a suitable thickness may range from 1.28 mm to 1.65 mm.

Also the core plate 54 comprises a first longitudinal edge 56a and a second longitudinal edge 56b, opposite to the first longitudinal edge 56a. These longitudinal edges 56a, 56b will define the bottom of the longitudinal guide track 32 (FIG. 3) within the guide bar 18.

Both the core plate 54 and the side plates 46, 48 are cut out, for example by laser cutting between respective longitudinal edges to define aperture arrangements to reduce the weight of the guide bar. The aperture arrangement 58 of the core plate 54 comprises a plurality of apertures, wherein in FIG. 5, some exemplary apertures of the aperture arrangement 58 are indicated by references signs 58a, 58b, 58c, 58d and 58e. The apertures of the aperture arrangement 58 together cover the main part of the area between the longitudinal edges 56a, 56b of the core plate 54. The apertures are elongated, and their direction of elongation extends in the longitudinal direction L of the guide bar 18. A frame 62 comprising the longitudinal edges 56a, 56ab of the core plate 54 encloses the aperture arrangement 58. Ribs 63, held by the frame 62, define aperture separation walls 60 which delimit the individual apertures of the aperture arrangement 58 and contribute to the torsional strength of the guide bar.

The core plate 54 extends on both sides of a longitudinal centre C (FIG. 3) of the guide bar 18 in the longitudinal direction L thereof. The nose wheel 38, as indicated in FIG. 3, is arranged at a distal end 55b in the longitudinal direction of the core plate 54 and is fixed between the side plates 46, 48 so that only its gear teeth (FIG. 3) are visible in the guide bar 18. A further aperture 59 is arranged at a proximal end 55a of the core plate 54 and contributes to reduce the weight of the core plate 54 further.

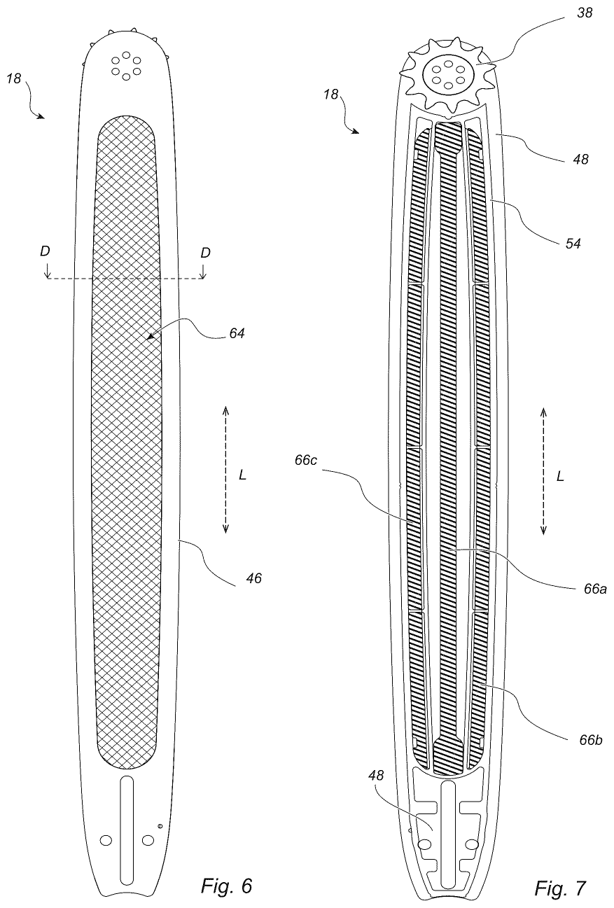

FIG. 6 illustrates the guide bar 18 of FIG. 3. The guide bar 18 is reinforced by plastic inserts 64. Preferably a fibre reinforced plastic material is used, and most preferably a carbon fibre reinforced plastic material is used. The carbon fibre reinforced plastic laminates 64 can be manufactured in several steps to provide a prebaked material and can be cut to a size and shape adapted to fit within the elongated opening 53 (FIG. 4) of each side plate 46, 48. When the plastic inserts 64 have been inserted in the respective elongated openings 53 of the side plates 46, 48, the inserts 64 will rest on the ribs 63 of the core plate 54, such that the core plate 54 acts as a spacer for the two plastic inserts 64.

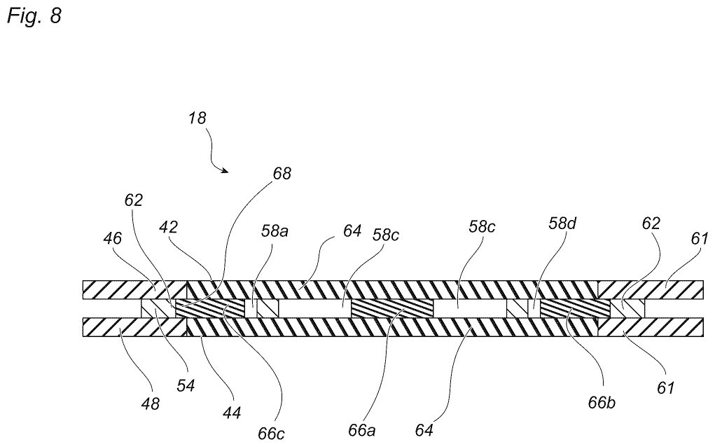

An adhesive 66 is introduced in the guide bar 18 to bond the plastic laminates 64 to the guide bar 18. The adhesive 66 can be applied as strings between the side plates 46, 48 and core plate 54, for example prior to inserting one of the plastic inserts 64 in the elongated openings 53. FIG. 7 illustrates the guide bar 18 with the outer side plate 46 removed after application of adhesive 66. One string of adhesive 66a is applied in the centre of the core plate 54 between the side plates 46, 48, along the longitudinal direction L, to bond the plastic inserts 64 together and/or to the core plate 54. Two strings of adhesive 66b, 66c are applied between the side plates 46, 48 along the inner edge of the frame 62 (FIG. 5) of the core plate 54, each string 66b, 66c extending in the longitudinal direction of the guide bar between the longitudinal edges 19a, 19b of the side plates 46, 48 and the longitudinal edges 56a, 56b of the core plate 54, which appears more clearly from FIG. 8, which is a cross-section along line D-D in FIG. 7. As indicated in FIG. 8, an interlock space 68 is formed between the longitudinal edges of the side plates 46, 48 and the inner edge of the frame 62 of the core plate 54. The two strings 66b, 66c interlock the plastic inserts 64 with the interlock spaces 68 between the frames of the side plates 46, 48 and forms a bond between the respective plastic inserts 64.

The adhesive 66 used is a 2-component adhesive of methacrylate. The adhesive cures at room temperature which simplifies fixturing during the bonding process. This kind of adhesive is suitable for relatively thick joints, as between the plastic inserts 64 and/or between the core plate 54 and the side plates 46, 48, and allows a certain elongation of the bond before breaking.

A guide bar 18 according to this example embodiment of the invention has the properties of being light, stiff and allows bending with reduced risk that the plastic laminates 64 detach from the guide bar 18 when the guide bar 18 is exposed to bending.

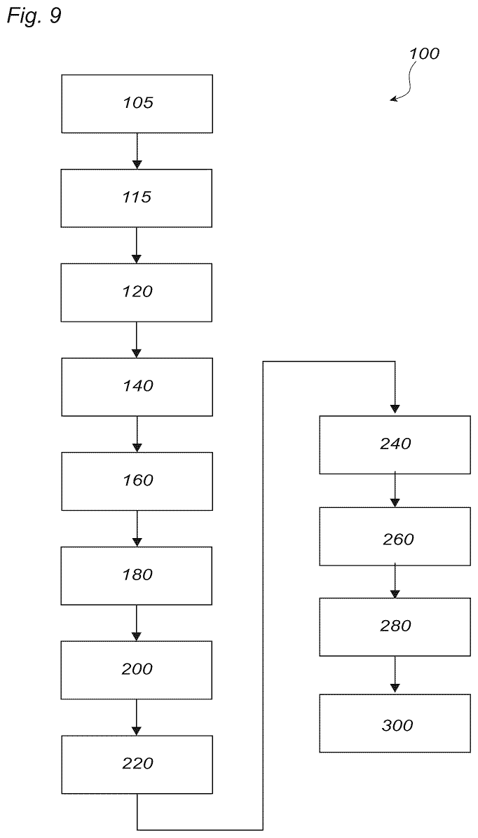

FIG. 9 illustrates a flow chart of a method 100 for assembling of the guide bar 18.

In a first step 105, a first 46 and a second 48 side plate are provided, each with an opening arrangement 52, with at least an elongated opening 53 extending in the longitudinal direction L of the guide bar 18 and fully through the respective side plate 46, 48.

In the second step 115, a core plate 54 with an aperture arrangement 58, comprising a plurality of apertures enclosed by a frame 62 and extending fully through the core plate 54, is provided.

In the next step, the stacking step 120, the core plate 54 is arranged between the first and second side plates 46, 48, such that the inner faces of the side plates 46, 48 abut the core plate 54, thereby forming a stacked sandwich structure. The opening arrangement 52 of each side plate 46, 48 is in register with the aperture arrangement 58 of the core plate 54.

In the welding step 140, the stacked sandwich structure is preheated to a temperature of about 160° C., and thereafter welded together to form a welded guide bar blank with a guide track 32 between the longitudinal edges 56a, 56b of the core plate 54 and the longitudinal edges 19a, 19b of the side plates 46, 48.

After welding 140, the weld seams (not indicated in the figures) may be machined, in an optional machining step 160, to be level with the outer faces 42, 44 of the side plates 46, 48.

In next step 180, the welded guide bar blank is hardened at a temperature of about 900° C. and quenched in an oil bath.

After hardening, the welded guide bar blank is placed in a fixture and clamped to assume a flat shape, and tempered in a tempering step 200, at a temperature of about 500° C. to alleviate any residual stress in the guide bar blank and the welded seams. The side plates and the core plate may be cut out from a pre-hardened material, it that case, the hardening and tempering steps may be omitted from the method.

After tempering, the longitudinal edges 19a, 19b of the welded guide bar blank are induction hardened in an induction hardening step 220 to a depth of about 1 mm.

In some embodiments, a nose wheel 38 may be riveted to the welded guide bar blank in the distal end 18b thereof, attached between the side plates 46, 48, in a nose wheel attachment step 240. The guide bar blank may then be painted in a painting step 260 to obtain a desired appearance.

After all treatment steps 120-260 of the guide bar 18 have been performed, each respective elongated opening 53 in in the outer faces 42, 44 of the guide bar 18 is provided, in step 280, with a plastic insert 64 so that the plastic inserts 64 abut the aperture separation walls 60 defined by the ribs 63 of the core plate 54, which determine the distance between the two plastic inserts 64. An adhesive 66 is injected, in adhesive application step 300, between the side plates and the core plate in the form of strings 66a, 66b, 66c to bond the plastic laminates 64 together. The adhesive 66 also bonds the plastic laminates 64 to the guide bar blank defined by the side plates 46, 46 and the core plate 54, to form the final guide bar 18 with improved bending properties.

The invention has mainly been described above with reference to a few embodiments. However, as is readily appreciated by a person skilled in the art, other embodiments than the ones disclosed above are equally possible within the scope of the invention, as defined by the appended patent claims.

For example, the welding method can be laser welding or spot welding and the weld seams do not need to fully penetrate to entire guide bar, it may be sufficient that the seams reach to a certain depth of the respective opposed side plates. The sandwich structure of the guide bar is not limited to three plates, it may comprise additional plates. The plastic laminates may be formed in the elongated openings by several layers of a fibrous material that are bond together with a resin. While the invention has been described with reference to a chainsaw driving a saw chain having cutting teeth adapted to cut wood, it is equally applicable to chainsaws driving saw chains provided with abrasive elements for cutting rock, concrete, and the like.

In the claims, the word “comprising” does not exclude other elements or steps, and the indefinite article “a” or “an” does not exclude a plurality.

What is claimed:

1. A guide bar for a handheld chainsaw comprising:
a first side plate, a second side plate and a core plate, wherein the core plate is arranged between the first side plate and the second side plate, the guide bar extending along a guide bar plane in a longitudinal direction,
wherein each of the first and second side plates is provided with a respective instance of an opening arrangement, the opening arrangement comprising at least one elongate opening extending in the longitudinal direction of the guide bar and fully through the first and second side plates, respectively, and
the core plate is provided with an aperture arrangement, comprising a plurality of apertures, each of the apertures extending fully through the core plate,
wherein each of the respective at least one elongated opening is provided with a respective plastic insert to collectively define a plurality of plastic inserts.

2. The guide bar according to claim 1, wherein each of the plastic inserts is separated from each other by the core plate.

3. The guide bar according to claim 1, wherein the aperture arrangement is at least partly positioned between the plastic inserts, such that the apertures are at least partly covered by the plastic inserts.

4. The guide bar according to claim 1, wherein the aperture arrangement covers at least 50% of an area enclosed by a perimeter of the core plate.

5. The guide bar according to claim 1, wherein each respective opening arrangement of the first and second side plates comprises exactly one elongated opening provided with one of the plastic inserts.

6. The guide bar according to claim 1, wherein each respective opening arrangement covers at least 50% of an area enclosed by a perimeter of a respective one of the first or second side plates.

7. The guide bar according to claim 1, wherein each respective opening arrangement covers 50-75% of an area enclosed by the perimeter of a respective one of the first or second side plates.

8. The guide bar according to claim 1, wherein the core plate is provided with a first and a second longitudinal edge, extending in the longitudinal direction of the guide bar, the longitudinal edges defining the bottom of a guide track for a saw chain and forming a part of a core plate frame enclosing the aperture arrangement.

9. The guide bar according to claim 8, wherein the core plate comprises ribs extending from the core plate frame.

10. The guide bar according to claim 1, wherein the guide bar has a proximal longitudinal end configured to be attached to a chainsaw body, a distal longitudinal end provided with a nose wheel, and a longitudinal centre between the proximal and distal longitudinal ends, wherein the core plate extends from the longitudinal centre towards each of the proximal and distal longitudinal ends.

11. The guide bar according to claim 8, wherein each of the first and second side plates is provided with a respective first longitudinal edge and a respective second longitudinal edge, opposite to the first longitudinal edge, extending in the longitudinal direction of the guide bar and defining a side plate frame enclosing the at least one elongated opening of the opening arrangement.

12. The guide bar according to claim 11, wherein the core plate and the first and second side plates are joined along their longitudinal edges.

13. The guide bar according to claim 1, wherein the core plate and the first and second side plates are welded together along the longitudinal direction of the guide bar.

14. The guide bar according to claim 1, wherein the guide bar is provided with an adhesive joining the plastic inserts in the first and second side plates, respectively, with each other.

15. The guide bar according to claim 1, wherein the plastic inserts are joined with the core plate and/or the first and second side plates by adhesive.

16. The guide bar according to claim 15, wherein the guide bar is provided with an interlock space between the first and second side plates and the core plate at their longitudinal edges, and the adhesive spans a gap between the plastic inserts, and is interlocked in the interlock space.

17. A method of manufacturing a guide bar for a handheld chainsaw, the method comprising:
providing a first side plate and a second side plate, each with an opening arrangement, with at least one elongated opening extending in a longitudinal direction of the guide bar and fully through respective ones of the first and second side plates,
providing a core plate with an aperture arrangement, comprising a plurality of apertures enclosed by a frame and extending fully through the core plate;
arranging the core plate between the first and second side plates to form a stacked sandwich structure;
welding the core plate to the first and second side plates to form an elongated guide bar blank, extending in the longitudinal direction of the guide bar; and
after welding the core plate to the first and second side plates, inserting a respective plastic insert in each of said at least one elongated opening of the opening arrangement of each of the first and second side plates.

18. The method according to claim 17, further comprising applying an adhesive for joining the plastic inserts with each other and/or with the elongated guide bar blank.

19. The method according to claim 17, further comprising steps of, before inserting the plastic inserts in the first and second side plates, respectively:
attaching a nose sprocket arrangement to a distal end of the elongated guide bar blank seen in the longitudinal direction thereof, between the first and second side plates; and
painting the elongated guide bar blank.

20. A guide bar manufactured using the method of claim 17.
